(19) United States
(12) Patent Application Publication
(10) Pub. No.: US 2025/0180065 A1
(43) Pub. Date: Jun. 5, 2025

(54) CONNECTING ROD WITH INTERNAL LUBRICANT RESERVOIR

(71) Applicant: Advanced Flow Solutions Inc., Oklahoma City, OK (US)

(72) Inventor: Blake A. Wallace, Mustang, OK (US)

(73) Assignee: Advanced Flow Solutions Inc., Oklahoma City, OK (US)

(21) Appl. No.: 18/958,391

(22) Filed: Nov. 25, 2024

Related U.S. Application Data
(60) Provisional application No. 63/604,346, filed on Nov. 30, 2023.

(51) Int. Cl. F16C 7/02

(52) U.S. Cl. CPC F16C 7/02; F16C 2226/00; F16C 2300/02

(57) ABSTRACT

One or more techniques and/or systems are disclosed for a connecting rod that can comprise a body configured to house an internal lubricant reservoir. The reservoir can house and supply lubricant to bearings coupled with the rod. These bearings may be in fluid communication with the internal reservoir, which can in-turn provide lubricant to the bearings. The rod or bearings may comprise at least one lubrication port fluidly coupling the lubrication port with the bearing, to facilitate the flow of lubricant from the reservoir to the bearing.

### CROSS-REFERENCE TO RELATED APPLICATIONS

This application claims priority to U.S. Provisional Patent Application Ser. No. 63/604,346, entitled CONNECTING ROD WITH INTERNAL LUBRICANT RESERVOIR, filed Nov. 30, 2023, which is incorporated herein by reference.

### BACKGROUND

Conventional machinery such as compressors, turbines, engines, gearboxes, and other rotational equipment typically rely on lubrication for smooth operation, a principle used in the functioning of connecting rods. Connecting rods are used in a wide array of machinery including engines and compressors and feature two distinct attachment points: the “big end” and the “small end.” The big end, rotating around a crankshaft journal, undergoes circular motion, whereas the small end engages in a reciprocating motion, rocking back and forth on a wrist pin. This dichotomy of motion at each end of the connecting rod helps in its primary function of converting rotating motion into reciprocating motion or vice versa, often for use in machinery involving pistons and crankshafts.

Continued efficiency of this motion conversion and the smooth operation of these machines can depend on the use and maintenance of bearings located at both ends of the connecting rod. These bearings can help to mitigate direct metal-to-metal contact between elements in motion, reducing friction, heat generation, and wear and tear of parts while improving efficiency. These bearings can be of two types: re-greaseable, often equipped with a grease fitting (e.g., a Zerk fitting) for periodic maintenance, or sealed, typically factory-lubricated but with a limited lifespan due to the restricted quantity of lubricant. Re-greaseable bearings, with regular maintenance, can have a prolonged life, whereas sealed bearings, devoid of a grease fitting, are “maintenance-free” but with the drawback of a limited lifespan, often chosen for locations where maintenance access is difficult, or a limited lifespan is acceptable. Each type of bearing, subject to different stresses and motions, can benefit from regular maintenance for desired function.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation a connecting rod may feature a body configured to house an internal lubricant reservoir, which may supply lubricant to bearings disposed in the rod. These bearings may be in fluid communication with the internal reservoir, thereby providing lubrication, and the bearings can comprise at least one lubrication port for the addition of lubricant, to facilitate the flow of lubricant from the reservoir to the bearing.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a side cross-sectional view of a connecting rod.

FIG. 2 is a front cross-sectional view of a connecting rod.

FIG. 3 is a side cross-sectional view of a connecting rod in operation.

FIG. 4 is a side cross-sectional view of a compressor.

FIG. 5 is a side cross-sectional view of a connecting rod.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

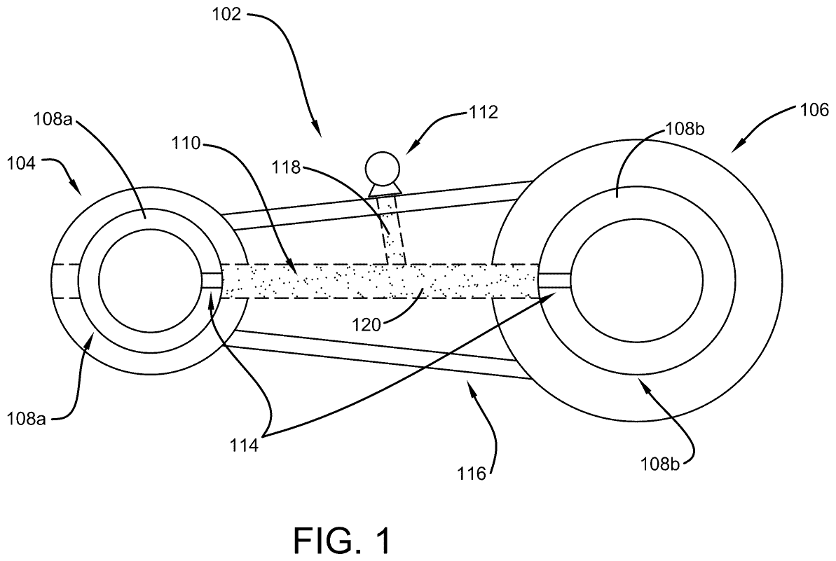

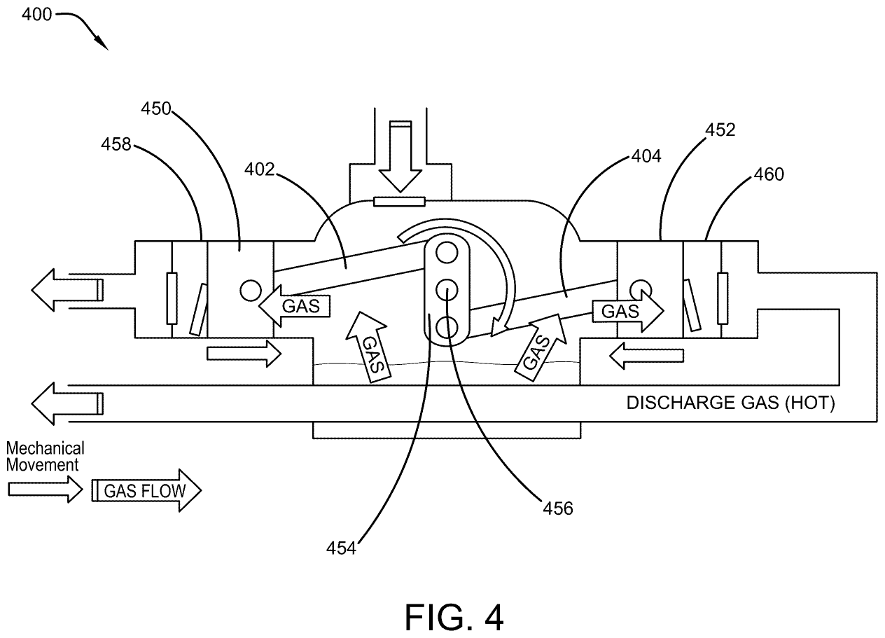

As illustrated in FIGS. 1-5, the disclosed implementations relate to a connecting rod, with an internal lubrication reservoir. The connecting rod may be particularly suited for use in machinery such as compressors, turbines, engines, and other rotational equipment where lubrication facilitates efficient operation. As an exemplary example, the connecting rod can be used in a crankcase system 400, as illustrated in FIG. 4. In this example, a crankcase compressor system 400 comprises a pair of pistons 450, 452 engaged with a crankshaft 454 via a pair of connecting rods 402, 404. As illustrated, the crankshaft 454 rotates from a central pivot point 456, while one end of the respective connecting rods 402, 404 is pivotably engaged with the crankshaft at its respective ends. In this way, the rotation of the crankshaft 454 provides for a reciprocating motion of the connecting rods 402, 404. In turn, the other end of the connecting rods 402, 404 is pivotably engaged with the pistons 450, 452, which reciprocate inside a cylinder chamber 458, 460 with the motion of the connecting rods 402, 404.

A traditional (and typical) compressor design uses pressurized oil lubrication or splash oil lubrication for the connecting rod journal and wrist pin bearings. This method is used in everything from small residential air compressors to large industrial gas compressors rated for thousands of horsepower. Other compressor designs are considered “oil-less” and contain no crankcase oil. Such oil-less compressors are considered lighter duty designs and use sealed bearings in the connecting rod. Sealed bearings are typically factory lubricated with a finite amount of grease and cannot be regreased. The potential life span of such a bearing is limited by the amount of grease the bearing can contain. These bearings, with a limited amount of grease, ultimately limit the compressor's run time before maintenance is required. Hence, oil-less compressors are considered “light duty” units.

An innovation in connecting rod design is described herein, which can extend the life of sealed bearings by providing an additional source of lubricant to the connecting rod bearings that otherwise have only the limited amount of lubricant inside the bearing itself. This new connecting rod design incorporates an internal lubricant reservoir that is connected to the bearing in one or both ends of the connecting rod to provide an additional source of lubricant for the bearings. With additional lubricant available for the bearing, the bearing life is extended, and the machine's maintenance intervals can be extended significantly.

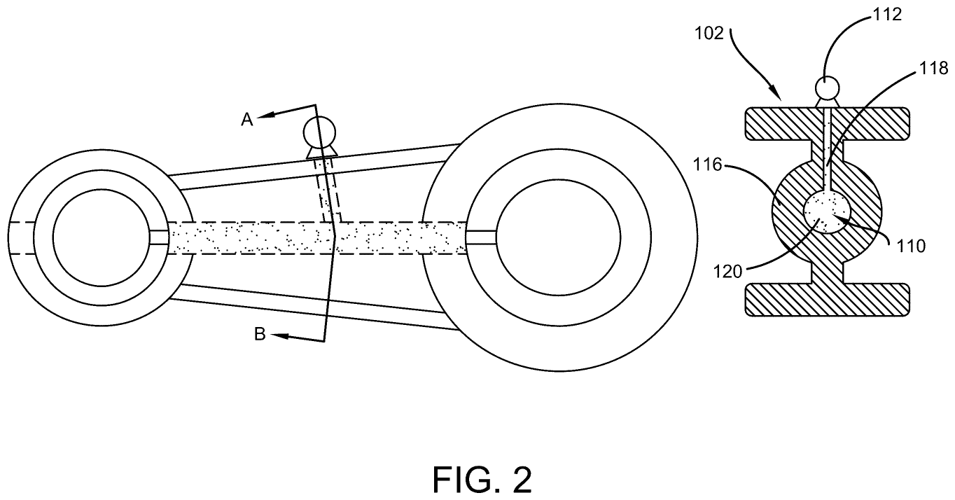

In one implementation of the present disclosure, as shown in FIGS. 1 and 2, a connecting rod 102 comprises a first end 104 and a second end 106. In this example the first end 104 is shown as a smaller connector than the second end 106, however alternate arrangements are contemplated. That is, both ends 104, 106 may be of the same or similar size, or the first end 104 may be larger than the second end 106, depending on the application and use of the connecting rod 102.

In these implementations, the connecting rod 102 comprises a bearing 108 (108a, 108b) at respective ends 104, 106. The bearings can be of a same or similar type, or may be different types. For example, a sealed wrist pin bearing may be used for the bearing 108a at the first end 104; and a sealed crankshaft journal bearing may be used for the bearing 108b at the second end 106. As mentioned above, bearings are often categorized as “re-greaseable” bearings or “sealed” bearings. Re-greaseable bearings are typically provided with a grease Zerk fitting that is used to periodically supply additional grease for the bearing during maintenance cycles. Such bearings can have a long life with regular maintenance. Sealed bearings lack a grease Zerk and are considered “maintenance free.” But this comes at the expense of a limited bearing life span due to the limited amount of grease available for the bearing. Sealed bearings are often used in locations where access for maintenance is difficult, impractical, or where a limited life span is acceptable (intermittent or light duty applications). In some implementations the bearings 108 can comprise roll-element bearings (e.g., with a raceway and ball bearing), or may be solid metallic or non-metallic bearings.

As illustrated, the connecting rod 102 can comprise an internal lubricant reservoir 110 that is configured to hold lubricant 120 inside a body 116 of the connecting rod. The internal lubricant reservoir 110 can hold and provide lubricant to the bearing 108 at one or both ends 104, 106 of the connecting rod 102. While the connecting rod 102 and connecting rod body 116 can take many different forms, the internal lubricant reservoir 110 can comprise a hollow, internal chamber that acts as a lubricant reservoir. Further, the internal lubricant reservoir 110 can be filled and replenished through a grease fitting 112 (e.g., Zerk fitting), which allows for the addition of lubricant 120 without disassembling the components. In this implementation, the grease fitting 112 is fluidly coupled with a supply passage 118, that is fluidly coupled with the internal lubricant reservoir 110. The grease fitting 112 may be used to inject lubricant into the lubricant reservoir 110 through the supply passage 118. The lubricant reservoir 110 is fluidly coupled with one or more bearing lubrication ports 114; and the bearing lubrication ports 114 lead to, and are fluidly coupled with, the bearings 108 or other moving parts.

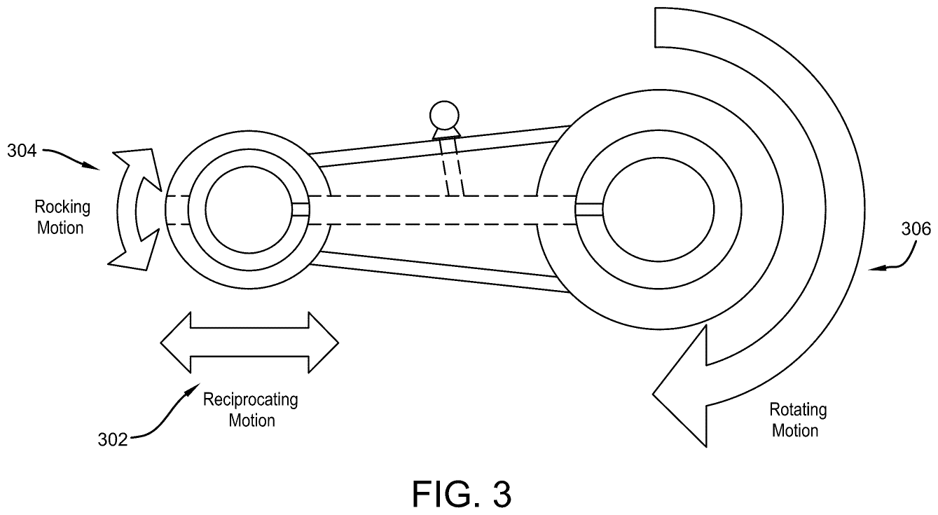

During operation, for example, as illustrated in FIG. 3, the inertial and centrifugal forces generated by the reciprocating 302, rocking 304, and rotating 306 motion of the connecting rod 102 will force lubricant 120 outward toward the ends 104, 106 of the connecting rod 102, and thus to the bearings 108. Further, for example, heat generated by the system and motion can also be transferred to the lubricant 120, which makes it less viscous and more likely to translate outward to the bearings 108. Thus, the bearing's lubricant supply can be replenished during operation. As illustrated, during operation, these inertial and centrifugal forces, along with potential heat transfer, can aid in radial distribution of the lubricant 120 to the bearing lubrication ports 114, which can provide lubrication to the bearings 108.

The materials for the connecting rod 102, reservoir 110, and associated components may be chosen based on factors such as temperature resistance, lubricant compatibility, and mechanical strength, and intended use. In another implementation of the present disclosure, the connecting rod 102 may be adapted to be compatible with a variety of machinery, including but not limited to high-performance engines, industrial compressors, and other heavy-duty machinery. The versatility of the connecting rod 102 with its internal lubrication reservoir 110 allows it to be used in a wide range of applications, from high-speed operations to heavy load bearing scenarios.

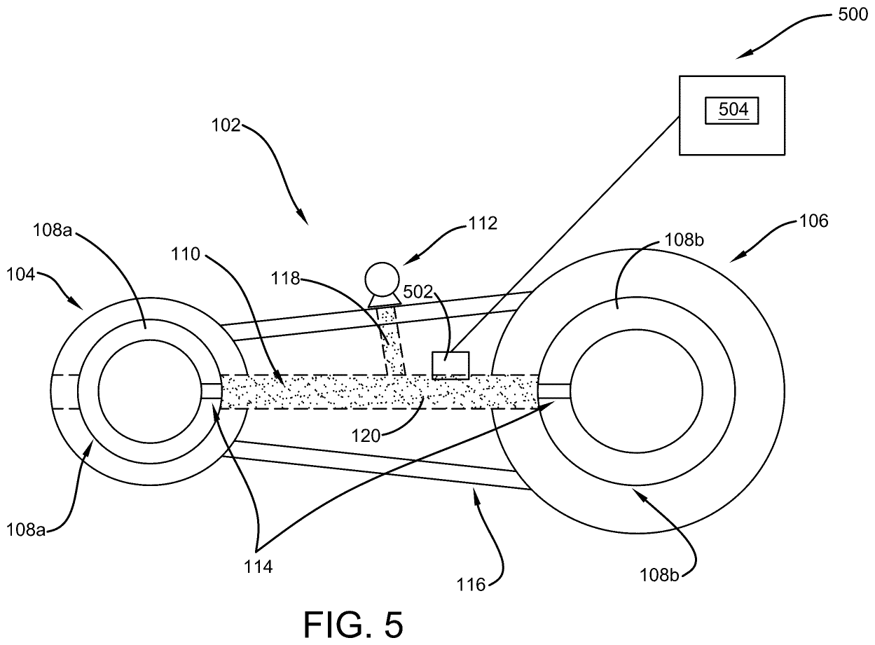

As illustrated in FIG. 5, the lubrication system of the connecting rod 102, in one implementation, may further include a sensor system 500 for monitoring the level of lubricant 120 within the reservoir 110. The sensor system 500 can comprise a sensor 502 that detects a level of lubricant 120, and a processing unit 504 that identifies the level, and can further provide alerts or signals, for example, to maintenance personnel when the lubricant level falls below a predetermined threshold. In this way, timely replenishment of the lubricant can be provided to help in uninterrupted operation of the machinery. As an example, a fluid sensing sensor 502 can be disposed inside or proximate the reservoir 110. At a predetermined level, the sensor 502 can send a signal to the processor 504 to detect a level or presence of the lubricant 120.

Additionally, in other implementations, the connecting rod 102 may include a self-regulating mechanism for controlling the flow of lubricant from the reservoir to the bearings. In this example, this mechanism may comprise valves or other flow control devices that adjust the lubricant flow based on the operational parameters of the machinery, such as speed, temperature, and load.

In yet another implementation, the connecting rod with the internal lubrication reservoir, and other features described herein, may be constructed from advanced materials such as high-grade steel, aluminum alloys, or composite materials. These materials may be selected for their strength, durability, and compatibility with various types of lubricants, including synthetic and mineral-based lubricants. Further, the reservoir may be cast with the connecting rod, or may be separately formed, such as through milling, drilling, or other means. Additionally, the supply passage 118 leading from the outside (e.g., connected to the grease fitting) can be cast with the connecting rod, or it may be formed by drilling, milling, etc. In some implementations, threads can be formed at the outside opening of the channel to accommodate complementary threads of the grease fitting, such that the grease fitting can be operably engaged with the connecting rod, and fluidly coupled with the channel and reservoir.

The connecting rod may also be designed for ease of assembly and disassembly within machinery. In one implementation, the connecting rod may feature modular components that can be quickly attached or detached from the main assembly, facilitating easy maintenance and replacement of parts.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A connecting rod comprising:
an elongate body comprising a first end and a second end, at least the first end configured to receive and hold a bearing in operation;
an internal lubricant reservoir disposed within the body, and configured to hold lubricant;
a first bearing disposed at the first end of the body, wherein the first bearing is in fluid communication with the internal lubricant reservoir to operably receive lubricant therefrom; and
a first lubrication port in fluid communication with the first bearing, the first lubrication port in fluid communication with the internal lubricant reservoir and configured to operably provide flow of lubricant from the internal lubricant reservoir to the first bearing.

2. The connecting rod of claim 1, wherein the internal lubricant reservoir comprises a hollow chamber centrally located within the connecting rod.

3. The connecting rod of claim 1, wherein the connecting rod is sealed, containing a finite amount of lubricant.

4. The connecting rod of claim 1, comprising a supply passage fluidly coupled with the internal lubricant reservoir and an external inlet port, wherein a lubrication fitting is removably attached to the external inlet port, allowing for the addition of lubricant to the internal lubricant reservoir.

5. The connecting rod of claim 1, comprising a second bearing disposed at the second end, the second bearing fluidly coupled with the internal lubricant reservoir.

6. The connecting rod of claim 5, comprising a second lubrication port fluidly coupled with the second bearing, the lubrication port in fluid communication with the internal lubricant reservoir and configured to operably provide flow of lubricant from the internal lubricant reservoir to the second bearing.

7. The connecting rod of claim 6, wherein the first and second lubrication ports are disposed in their respective bearings.

8. The connecting rod of claim 1, comprising a lubrication sensor, the lubrication sensor operable to detect a level of lubricant disposed in the internal lubricant reservoir.

9. The connecting rod of claim 8, comprising a processor that receives a signal from the lubricant sensor and provides an alert operable to be detected by an operator.

10. The connecting rod of claim 1, wherein the internal lubricant reservoir is sized and shaped to operably translate lubricant to one or both ends during operation based at least on a rocking, rotating, and/or reciprocating motion of the connecting rod.

11. A connecting rod comprising:
a body forming an internal lubricant reservoir wherein the internal lubricant reservoir is configured to hold lubricant;
a first bearing disposed at a first end of the body and a second bearing disposed at a second end of the body, wherein both the first bearing and the second bearing are in fluid communication with the internal lubricant reservoir;
a first lubrication port in fluid communication with the first bearing and the internal lubricant reservoir; and
a second lubrication port in fluid communication with the second bearing and the internal.

12. The connecting rod of claim 11, wherein the internal lubricant reservoir is replenishable via an external lubrication fitting, allowing for the addition of lubricant to the internal lubricant reservoir.

13. The connecting rod of claim 11, comprising a supply passage fluidly coupled with the internal lubricant reservoir and an external inlet port, wherein a lubrication fitting is removably attached to the external inlet port, allowing for the addition of lubricant to the internal lubricant reservoir.

14. The connecting rod of claim 11, wherein the respective bearings comprise sealed bearings.

15. The connecting rod of claim 11, wherein the internal lubricant reservoir is configured to utilize inertial and centrifugal forces generated during operation to facilitate the distribution of lubricant to the bearings.

16. The connecting rod of claim 11, where the internal lubricant reservoir is configured to allow heat transfer from an external source to lubricant within the internal lubricant reservoir.

17. The connecting rod of claim 11, further comprising a first flow restrictor disposed between the first lubrication port and the internal lubricant reservoir, and a second flow restrictor disposed between the second lubrication port and the internal lubricant reservoir, respective flow restrictors configured to merely allow a predetermined amount of lubricant into their respective lubrication ports.

18. The connecting rod of claim 11, wherein the first and second lubrication ports are disposed in their respective bearings.

19. A method of making a connecting rod, the method comprising:
forming a body of a connecting rod comprising a first end and a second end, the forming comprising forming a hollow internal lubricant reservoir;
disposing a first bearing at the first end of the body and a second bearing at the second end of the body, wherein the first bearing and the second bearing are in fluid communication with the internal lubricant reservoir; and
filling the internal lubricant reservoir with lubricant from a grease fitting disposed externally to the body, the grease fitting in fluid communication with a supply passage that is fluidly coupled with the internal lubricant reservoir.

20. The method of claim 19, further comprising forming a first lubrication port, wherein the first lubrication port in fluid communication with the first bearing and with the internal lubricant reservoir, and is configured to operably provide flow of lubricant from the internal lubricant reservoir to the first bearing.
